(19) United States
(12) Patent Application Publication
(10) Pub. No.: US 2020/0124071 A1
(43) Pub. Date: Apr. 23, 2020

(54) Robotically Compatible Erectable Joint with Noncircular Cross Section

(71) Applicant: UNITED STATES OF AMERICA AS REPRESENTED BY THE ADMINISTRATOR OF NASA, WASHINGTON, DC (US)

(72) Inventors: William R. Doggett, POQUOSON, VA (US); BRUCE D. KING, YORKTOWN, VA (US); JOHN T DORSEY, YORKTOWN, VA (US); STEPHEN J. HALES, POQUOSON, VA (US); CHRISTOPHER S. DOMACK, CARROLLTON, VA (US)

(21) Appl. No.: 16/660,277

(22) Filed: Oct. 22, 2019

Related U.S. Application Data
(60) Provisional application No. 62/749,306, filed on Oct. 23, 2018.

(51) Int. Cl. F16B 7/04; B64G 1/64

(52) U.S. Cl. CPC F16B 7/042; B64G 1/641

(57) ABSTRACT

Systems, methods, and devices of the various embodiments may provide a joint suitable for use with space systems, such as robotic space systems, (e.g., Extra Vehicular Activity (EVA) space systems, Intra Vehicular Activity (IVA) space systems, etc.), etc. Various embodiments provide a joint configured to enable structural connection of structural elements, such as trusses, antenna boom sections, beams, etc., including cantilevered elements. Various embodiments provide a joint configured to enable connection of truss structure sections. Various embodiments may provide a robotic erectable joint including an active joint half and a passive joint half configured to connect to the active joint half to thereby form the robotic erectable joint when so connected, wherein the robotic erectable joint has a noncircular cross section (e.g., polygon (e.g., square, triangle, hexagon, etc.) cross section, oval cross section, ellipse cross section, etc.).

### CROSS-REFERENCE TO RELATED PATENT APPLICATION(S)

This patent application claims the benefit of and priority to U.S. Provisional Patent Application No. 62/749,306, filed on Oct. 23, 2018, the contents of which are hereby incorporated by reference in their entirety.

### STATEMENT REGARDING FEDERALLY SPONSORED RESEARCH OR DEVELOPMENT

The invention described herein was made in the performance of work under a NASA contract and by employees of the United States Government and is subject to the provisions of the National Aeronautics and Space Act, Public Law 111-314, § 3 (124 Stat. 3330, 51 U.S.C. Chapter 201), and may be manufactured and used by or for the Government for governmental purposes without the payment of any royalties thereon or therefore.

### OVERVIEW

As robotic space systems become more prevalent, there is a need to reconsider space construction methods and tools. One example area where space construction methods may present shortcomings is that of using a robot to assemble or connect an antenna reflector dish to a boom on a spacecraft in geosynchronous orbit. Some space-based assemblies have used the legacy two inch erectable joint developed by Harold Bush and described in U.S. Pat. No. 4,963,052. However, several shortcomings and limitations of the legacy two inch joint are apparent when looking to use robotic space systems for antenna assembly. For example, the legacy two inch joint was designed to be inserted into a truss system and optimized for linear axial load transfer, with little or no concern for its bending or torsional load capabilities. In addition, the legacy two inch joint served a purely structural function and had no previsions for including electrical connectors or minimizing the electrical resistance across the joint which are beneficial to antenna construction. Further, because the legacy two inch joint was designed for Extra Vehicular Activity (EVA) assembly by astronauts without tools, the legacy two inch joint effectively had a tool included in each joint to allow the EVA astronaut to actuate the legacy two inch joint, which increases the complexity, mass, and manufacturing costs. Finally, the legacy two inch joint had a circular cross section to allow easy handling with the EVA glove which is not optimum for compact packaging, rotational alignment, or resistance of torsional moments.

### BRIEF SUMMARY

Systems, methods, and devices of the various embodiments may provide a joint suitable for use with space systems, such as robotic space systems, manual space systems, (e.g., Extra Vehicular Activity (EVA) space systems, Intra Vehicular Activity (IVA) space systems, etc.), etc. Various embodiments provide a joint configured to enable structural connection of structural elements, such as trusses, antenna boom sections, beams, etc., including cantilevered elements. Various embodiments provide a joint configured to enable connection of truss structure sections. Various embodiments provide a joint representing an improvement in transmitting shear, bending, and torsion loads, maintaining linear stiffness under all load conditions, and achieving repeatable assembly precision and accuracy about and along all axes in comparison to current joints.

Various embodiments may provide a robotic or manual erectable joint including an active joint half and a passive joint half configured to connect to the active joint half to thereby form the robotic or manual erectable joint when so connected, wherein the robotic or manual erectable joint has a noncircular cross section (e.g., polygon (e.g., square, triangle, hexagon, etc.) cross section, oval cross section, ellipse cross section, etc.). In some embodiments, the active joint half may include a stop plate in a drive train, wherein the stop plate is configured to cause an unlocked state of the active joint half to be unstable, wherein the joint snaps back to a captured state. In some embodiments, the stop plate may be configured such that a constant torque is required to unlock the robotic or manual erectable joint after the active joint half and the passive joint half are connected. In some embodiments, the active joint half may include a capture spring and a preload spring, and the robotic or manual erectable joint may be configured such that a force of the capture spring and a force of the preload spring may either or both be adjusted after the active joint half and the passive joint half are assembled or connected. In some embodiments, the active joint or passive joint may include a bonding strap configured to provide a low resistance electrical path across the robotic or manual erectable joint, or a portion of the joint, after the active joint half and the passive joint half are connected. In some embodiments, the active joint half and the passive joint half may each include a respective electrical connector configured to align with one another to form an electrical connection between the active joint half and the passive joint half. In some embodiments, the respective electrical connectors may be located away from structural contact surfaces of the robotic or manual erectable joint. In some embodiments, the joint contact surfaces maybe configured to provide precise positional and/or rotational alignment about and along a specific axis or set of axes. In some embodiments, the joint may include specific visual indicators to allow an operator or sensor to verify the joint is properly aligned, open, captured, and/or locked.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram of a robotic erectable joint with a noncircular cross section showing the active joint half separated from the passive joint half, in accordance with one or more embodiments.

FIG. 2 is a block diagram of the robotic erectable joint of FIG. 1 showing the active joint half and the passive joint half connected, in accordance with one or more embodiments.

FIG. 3A is a sectional view along the sectional line AA as shown in FIG. 2 of the erectable joint of FIG. 1 looking in the positive x direction, in accordance with one or more embodiments.

FIG. 3B is another sectional view along the sectional line AA as shown in FIG. 2 of the erectable joint of FIG. 1 looking from an elevated perspective along the x direction, in accordance with one or more embodiments.

FIG. 4 is a block diagram illustrating differences between packing efficiency of noncircular cross section robotic erectable joints and circular cross section joints, in accordance with one or more embodiments.

FIG. 5 is a cross section view of a noncircular cross section robotic erectable joint having an electrical bonding connection, in accordance with one or more embodiments.

FIG. 6A is a cut-away block diagram of a noncircular cross section robotic erectable joint having an electrical connection between the active joint half and the passive joint half that mates via movement in the insertion plane, such as the plane yz of FIG. 2, in accordance with one or more embodiments.

FIG. 6B is a partial cut-away block diagram of the joint of FIG. 6A, in accordance with one or more embodiments.

FIG. 7 is a cut-away block diagram of a noncircular cross section robotic erectable joint having an electrical connection between the active joint half and the passive joint half that mates via movement along an axis parallel to the x axis of FIG. 2, in accordance with one or more embodiments.

FIG. 8 is a block diagram of an installation tool for operating on a noncircular cross section robotic erectable joint, in accordance with one or more embodiments.

FIG. 9 is a block diagram of an example operator view of an installation tool, such as the installation tool of FIG. 8, showing an embodiment of a visual alignment indicator.

FIG. 10A is a block diagram of a robotic erectable joint with a noncircular cross section including a repeatable alignment connector, in accordance with one or more embodiments.

FIG. 10B illustrates another view of the repeatable alignment connector of FIG. 10A, in accordance with one or more embodiments.

FIG. 10C is a cross-sectional view of the repeatable alignment connector of FIG. 10A, in accordance with one or more embodiments.

FIGS. 11A and 11B are a block diagrams of a robotic erectable joint with a noncircular cross section including coarse alignment structures showing the joint halves connected, in accordance with one or more embodiments.

FIG. 11C is a block diagram of the robotic erectable joint of FIGS. 11A and 11B showing the joint halves separated from one another, in accordance with one or more embodiments.

FIG. 12A is a block diagram of the robotic erectable joint of FIGS. 11A and 11B showing the joint halves connected, in accordance with one or more embodiments.

FIG. 12B is a partial cut-away block diagram of the robotic erectable joint of FIGS. 11A and 11B showing the internal interactions of the coarse alignment structures, in accordance with one or more embodiments.

FIG. 13A is a block diagram of a robotic erectable joint with a noncircular cross section showing a first joint half and a second joint half connected, in accordance with one or more embodiments.

FIG. 13B is a close up view of a repeatable alignment connector of the joint of FIG. 13A, in accordance with one or more embodiments.

FIG. 13C is another close up view of the repeatable alignment connector of the joint of FIG. 13A, in accordance with one or more embodiments.

FIG. 14 is a block diagram of the joint of FIG. 13A showing the first joint half and the second joint half separated, in accordance with one or more embodiments.

FIG. 15 is a cut-away view of the joint of FIG. 13A, in accordance with one or more embodiments.

FIGS. 16 and 17 are block diagrams of a robotic erectable joint with a noncircular cross section showing a first joint half and a second joint half connected, in accordance with one or more embodiments.

### DETAILED DESCRIPTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The word “exemplary” is used herein to mean “serving as an example, instance, or illustration.” Any implementation described herein as “exemplary” is not necessarily to be construed as preferred or advantageous over other implementations.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments and/or implementations of the present disclosure may be described as providing one or more advantages and/or benefits. It is understood that such advantages and/or benefits may not be provided by all embodiments and/or implementations. Discussion of such advantages and/or benefits are not intended to limit the scope of the invention or the claims.

Various embodiments may be discussed in terms of various states of portions of a joint being physically joined together or connected. As discussed herein, when two portions of a joint are not in physical contact, the joint may be referred to as disconnected or in a disconnected state. As discussed herein, when two portions of a joint are in physical contact, the state of the joint may vary. As one example, two portions of a joint in physical contact with one another, but not locked together, may be referred to as in an open state. As another example, two portions of a joint in physical contact such that structures of the joint portions are aligned with one another, but the joint portions are not locked together, may be referred to as in a capture state. As another example, two portions of a joint in physical contact such that structures of the joint portions are aligned with one another and the joint portions are locked together may be referred to as in a locked state.

Various embodiments may provide a noncircular cross section (e.g., polygon (e.g., square, triangle, hexagon, etc.) cross section, oval cross section, ellipse cross section, etc.) robotic or manual erectable joint having an active joint half and a passive joint half configured to connect to the active joint half to thereby form the robotic or manual erectable joint when so connected. The noncircular cross section (e.g., polygon (e.g., square, triangle, hexagon, etc.) cross section, oval cross section, ellipse cross section, etc.) robotic or manual erectable joints of the various embodiments may be configured for use in space systems, such as robotic space systems, manual space systems, (e.g., EVA space systems, IVA space systems, etc.), etc., and may be robotically assembled and/or manually assembled (e.g., EVA assembled, IVA assembled, etc.) joints.

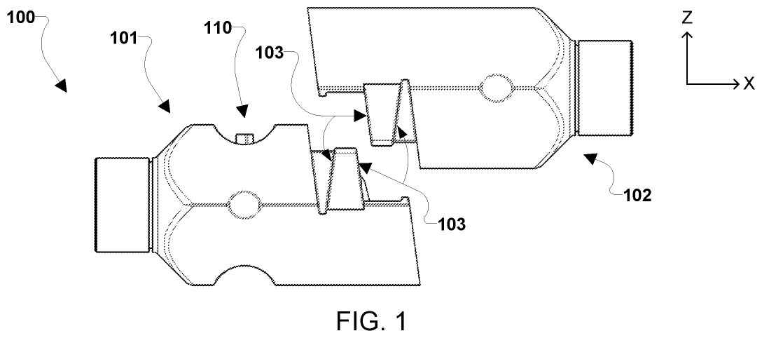

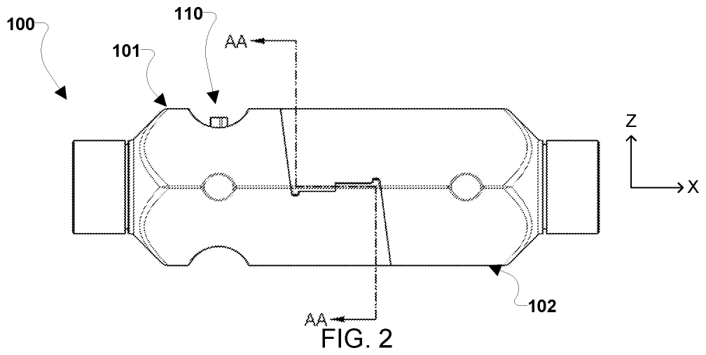

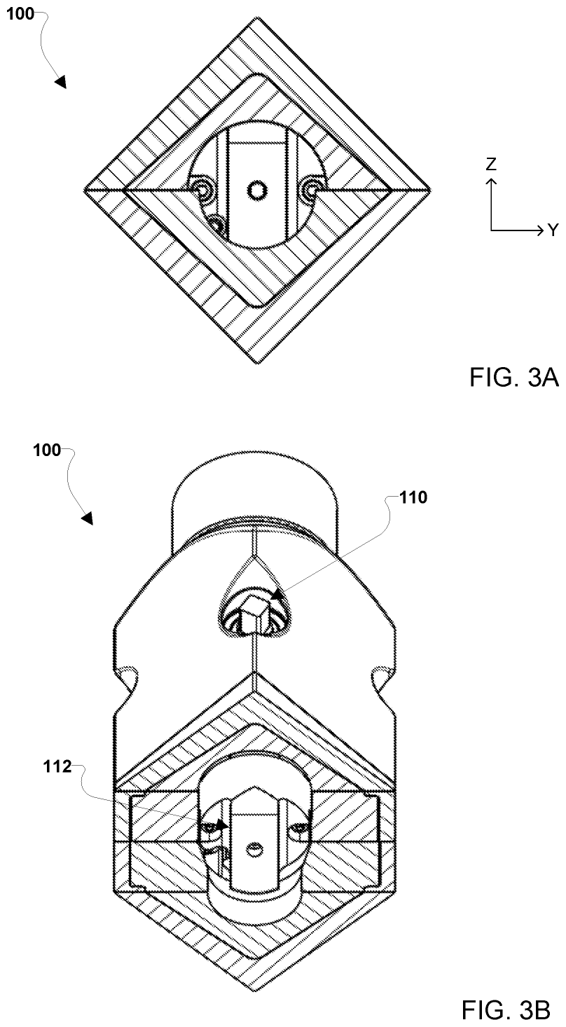

FIG. 1 illustrates an example of such a robotic erectable joint 100 with a noncircular cross section (e.g., polygon (e.g., square, triangle, hexagon, etc.) cross section, oval cross section, ellipse cross section, etc.) showing the active joint half 101 separated from the passive joint half 102, in accordance with one or more embodiments. The robotic erectable joint 100 is based on a square cross section, as shown in FIG. 3A. FIG. 2 illustrates the assembled robotic erectable joint 100 having the active joint half 101 and the passive joint half 102 joined together. In various embodiments, the robotic erectable joint 100 joint includes two halves, usually a passive joint half 102 and an active joint half 101, although both halves may be active in some embodiments. The two halves 101, 102 may be aligned, brought together, and one or more mechanisms, such as lock 112 (shown in FIG. 3B) actuated by drive shaft 110, driven to lock the robotic erectable joint 100. For example, these aligning and locking functions may be performed by a robotic controlled tool, with the tool optimized for robust assembly and the robotic erectable joint 100 optimized for performance.

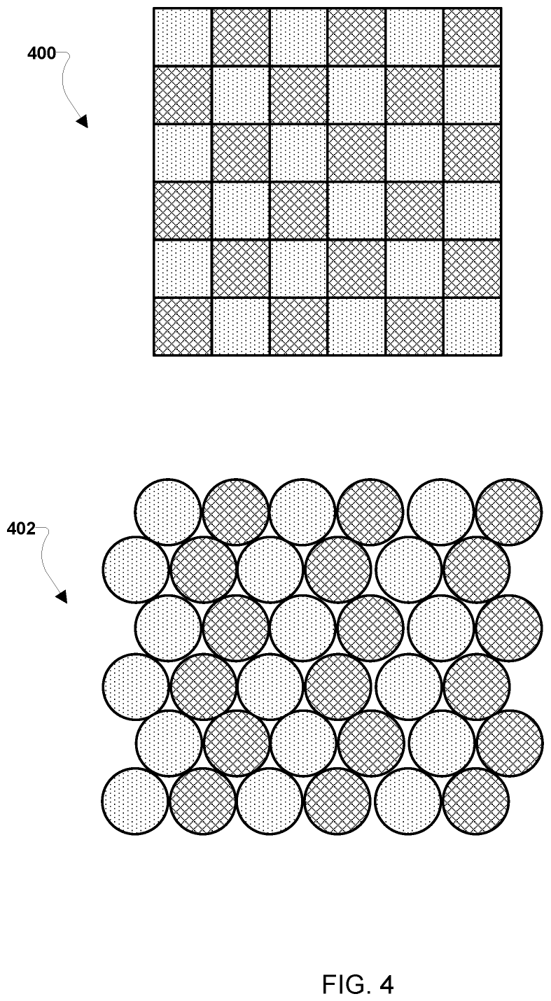

The noncircular cross section (e.g., polygon (e.g., square, triangle, hexagon, etc.) cross section, oval cross section, ellipse cross section, etc.) of some various robotic or manual erectable joints (e.g., robotic erectable joint 100) may provide many advantages over circular cross section joints. First, the noncircular robotic or manual erectable joint may be packaged more efficiently than a circular cross section joint, with noncircular tubes eliminating the gaps between the joints when stacked. For example, FIG. 4 illustrates a packaging of square cross section joints 400 compared to a packaging of circular cross section joints 402. There are significant gaps between the circular cross section joints in package 402, but no gaps in package 400. Second, for a specified maximum cross section dimension, the noncircular tubes of the noncircular cross section robotic or manual erectable joints may provide a larger moment-of-inertia compared to the circular tubes with a similar launch package, resulting in higher structural efficiency for the noncircular tubes of the various embodiments.

The noncircular cross section (e.g., polygon (e.g., square, triangle, hexagon, etc.) cross section, oval cross section, ellipse cross section, etc.) of noncircular cross section robotic or manual erectable joints may also provide several structural performance and operational advantages over the circular cross section. First, when engaged, the noncircular cross section of the noncircular cross section robotic or manual erectable joints may prevent rotation about the x axis while reacting torsional loads and provides rotational alignment about the x axis as defined in FIGS. 1-3B. This is a significant departure from the legacy two inch joint which was designed to be included within a truss and thus did not need to resist torques or have precise rotational alignment. Achieving accurate rotational alignment is a critical requirement for boom supported reflector applications, because this alignment directly impacts reflector alignment and the ability to accurately transmit the beam energy to a specific spot on the Earth, which is a requirement of the telecommunications sector. Second, in one or more embodiments, noncircular cross section robotic or manual erectable joints may enable a larger contact zone than legacy joints and that extends a farther distance from the joint centerline compared to the legacy joints. This leads to increased stiffness and load carrying efficiency from a mass and volume perspective. This increased contact area 103 is illustrated in FIG. 1A, where the contact surface 103 of the square cross section robotic erectable joint 100 fully surrounds the center of the joint 100 which is different than the partial contact surface of the legacy two inch joint. Thus, the axial load is distributed over a larger area of the noncircular cross section robotic erectable joint 100 compared to the legacy joint, reducing the resulting the stresses in the joint 100 compared to the legacy joint. Third, the larger contact zone and larger average radius of the contact zone improves the bending response of the noncircular cross section robotic erectable joint 100 compared to the legacy joint. Fourth, the larger cross-sectional area of the noncircular cross section robotic erectable joint 100 compared to the legacy joint, for a given packaging volume, reduces the shear stress in the joint 100 compared to the legacy joint.

In a cantilevered application, the boom must resist bending and shear loads in addition to the axial and torsional loads discussed previously. As noted previously, the legacy joint, when included within a truss, was not subjected to bending, torsion, or shear forces. The legacy joint has non-linear stiffness as well as hysteresis in bending about the z axis and the bending stiffness is generally poor in bending about both the y and z axes because of the small zone of structural contact and gaps between joint features when a bending load is applied. In contrast, in some implementations, the noncircular cross section robotic erectable joint 100 may have significant bending capability about both y and z axis due to the large contact zones and may not exhibit significant non-linearity or hysteresis.

In accordance with one or more embodiments, the noncircular cross section robotic erectable joint 100 may be simpler to manufacture than the legacy joint because: 1) the noncircular geometry of the noncircular cross section robotic erectable joint 100 may be more amenable to manufacturing; and/or 2) the features needed to enable EVA assembly with a circular joint may be eliminated from the noncircular cross section robotic erectable joint 100. Some EVA features of the legacy joint include: special safety locking features designed to prevent inadvertent unlocking of the joint, a grooved exterior barrel to provide grip surface and the large cam surfaces to provide mechanical advantage for easy manual locking. These features may be omitted in one or more implementations of the noncircular cross section robotic erectable joint 100.

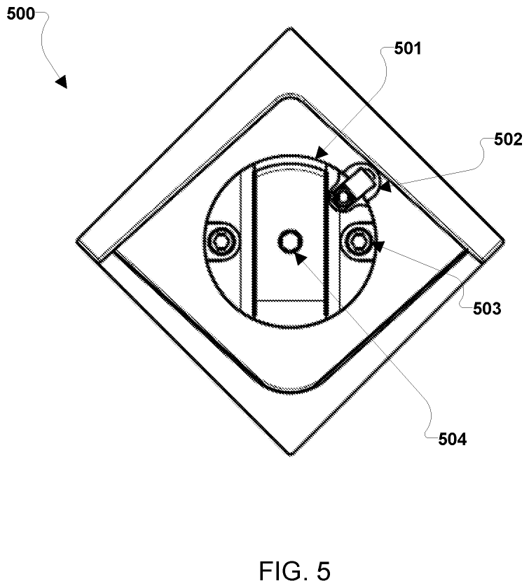

In one of more embodiments, a noncircular cross section (e.g., polygon (e.g., square, triangle, hexagon, etc.) cross section, oval cross section, ellipse cross section, etc.) robotic or manual erectable joints may include one or more of several features to improve reliability, performance, and/or robustness. FIGS. 5, 6A, 6B, and 7 illustrate some various such features in noncircular cross section robotic erectable joints 500, 600, and 700, respectfully. In some embodiments, a noncircular cross section robotic erectable joint, such as joint 700, may include a unique stop plate 704 in the drive train that may be configured to cause the unlocked state to be unstable, so that the joint 700 defaults to the capture state. In the capture state, the joint 700 may be forced together and the joint 700 may be secure (captured and held in place so it cannot come apart), but it does not necessarily have a preload and cannot resist significant forces and moments. In some implementations, the stop plate 704 may be configured so that a constant torque is required to unlock the joint 700, and should this torque be removed, the joint 700 may rapidly revert back to the capture state. In some embodiments, a noncircular cross section robotic erectable joint, such as joint 500, may be configured to enable the spring compressions to be adjusted when the joint 500 is fully assembled such as via capture spring adjustment paths 503 and preload spring adjustment path 504. In this manner, the preload spring force capture spring force may be adjusted. In a similar way, features may be included to enable the capture spring force to be adjusted.

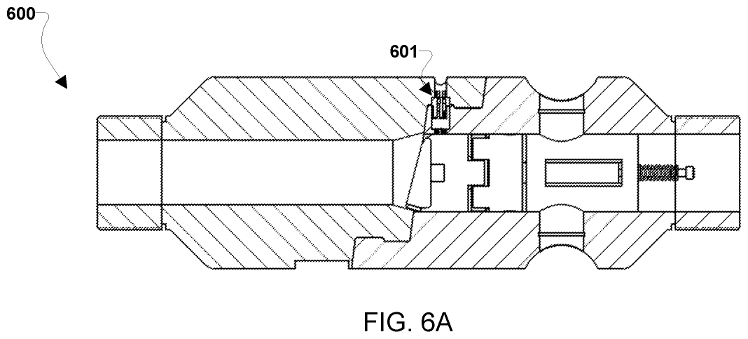

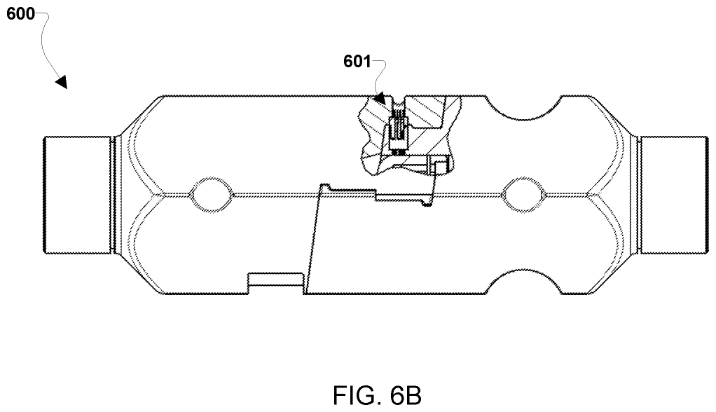

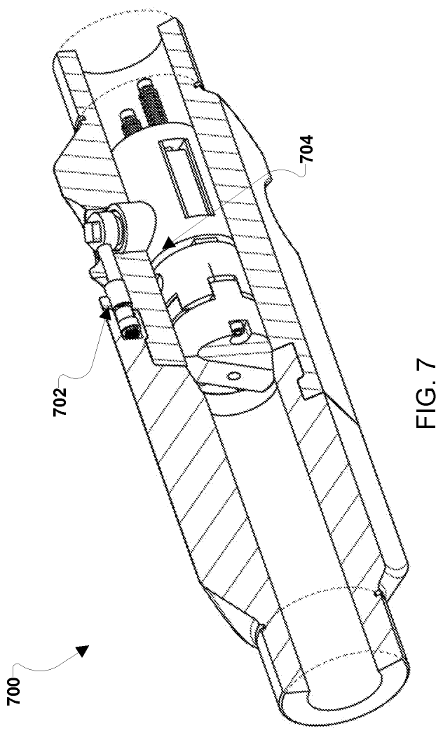

In addition to the structural features, in some embodiments the functionality of a noncircular cross section (e.g., polygon (e.g., square, triangle, hexagon, etc.) cross section, oval cross section, ellipse cross section, etc.) robotic or manual erectable joint may be expanded to included electrical features. For example, a bonding strap 502 may be installed to provide a low resistance electrical path across the mechanism that actuates the joint 500 as well as the contact surfaces used to transfer preload. The bonding strap 502 may form a bonding connection between the joint 500 body and plunger of the joint 500 across the sliding interface of the latch bolt. The bonding connection may establish a conductive path between the two portions of the joint 500, thereby connecting the two portions together such that the joint 500 has a single electrically ground path. The contact surfaces may be treated with bonding surface treatment 501 to provide a low resistance electrical path across the joint 500. The contact surfaces may be lubricated, such as with a dry lubricant. The treated region 501 of the active joint half is shown in FIG. 5 and there may be a corresponding treated zone on the passive joint half. Also, electrical connectors may be added in a number of locations within a noncircular cross section (e.g., polygon (e.g., square, triangle, hexagon, etc.) cross section, oval cross section, ellipse cross section, etc.) robotic or manual erectable joint to allow transfer of power and data across the joint, one example of which is shown in FIGS. 6A and 6B where an electrical connection 601 is inserted between the halves of the joint 600 supporting connection in the insertion plane, plane yz of FIG. 1. The electrical connections, such as connection 601, may be purposely located away from the structural contact surfaces. The connection option shown in FIGS. 6A and 6B may be engaged as the joint is assembled and may require no auxiliary linkages. Alternatively, an axial electrical connection 702, like that shown in FIG. 7, may be used which, in this case, may be driven off of the locking mechanism and actuates parallel to the x axis of FIG. 1.

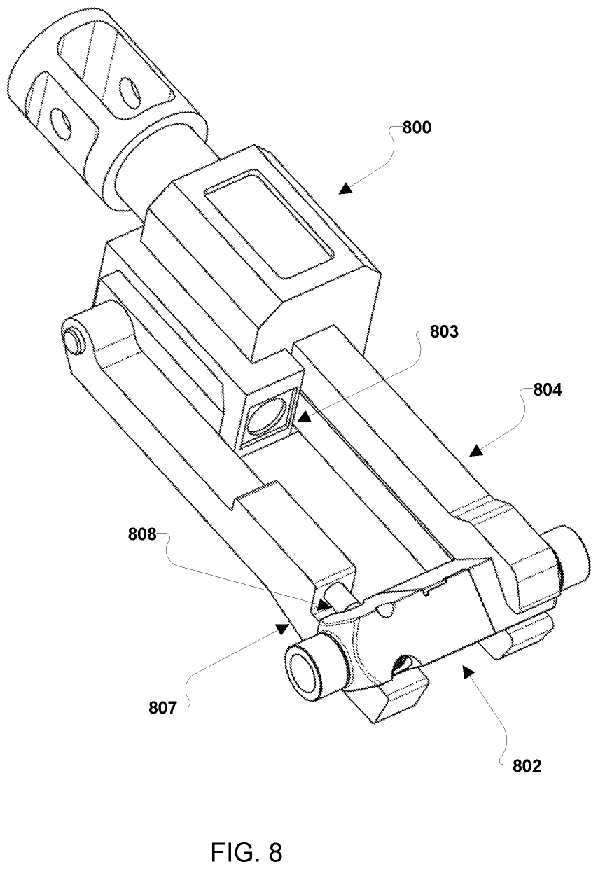

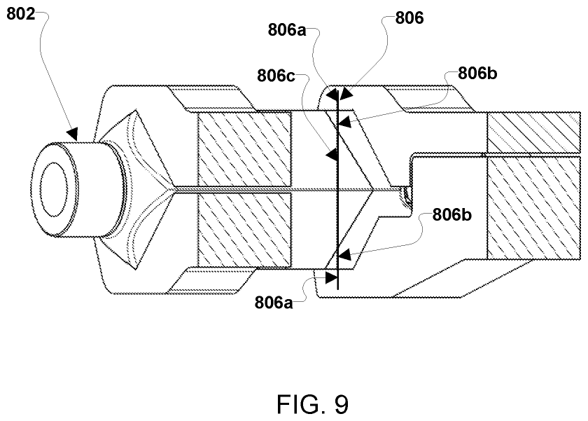

In one or more embodiments, noncircular cross section (e.g., polygon (e.g., square, triangle, hexagon, etc.) cross section, oval cross section, ellipse cross section, etc.) robotic erectable joints may be configured to operate symbiotically with an installation/removal tool controlled by a space-based robot. A version of such a tool 800 is shown in FIG. 8. The tool 800 includes features and functions required to perform robust alignment and assembly while the joint 802 provides a structurally efficient connection, thus minimizing the parasitic mass and complexity required (in the joint 802) to enable the connection. In various implementations, robust alignment and assembly features provided by the tool 800 may include: 1) large capture envelopes, 2) operator cameras and lights 803 and feedback (both electrical and optical) to verify proper installation and locking of the joint 802, 3) surfaces for locally reacting loads during installation/removal (freeing the structure or robot from these requirements), 4) a mechanism to insert/remove the joint, and/or 5) a mechanism to actuate the joint (e.g., a lock and unlock drive 808). Because the tool 800 provides proper joint 802 alignment prior to installation, the joint 802 may be optimized to meet long term operational performance requirements. This enables tight tolerances on machined components and close spacing of electrical contacts. Additionally, the active joint half may be actuated by a tool drive for robotic or EVA compatibility. The tool drive may be customized to trade its size against the tool drive motor torque required to lock and unlock the joint 802. An example optical verification indicator is shown in FIG. 9 as grip indicator 806. FIG. 9 is a view from the operator's perspective through the camera of the grip indicator 806. In some implementations, the grip indicator 806 may include a series of lines 806a, 806b, and 806c drawn on portions of the grip and joint halves. For example, an upper portion and a lower portion of the gripper may each have a line portion 806a on their surfaces, one joint half may have line portions 806b drawn on its surface, and the other joint half may have line portion 806c drawn on its surface. A properly aligned grip and joint halves may result in the indicator portions 806b and 806c on the joint aligning with indicator portions 806a on the grippers (i.e., active gripper 807 and/or passive gripper 804) to form a straight line (i.e., full and aligned indicator 806 formed from aligned portions 806a, 806b, and 806c) from the operator's perspective as shown in FIG. 9.

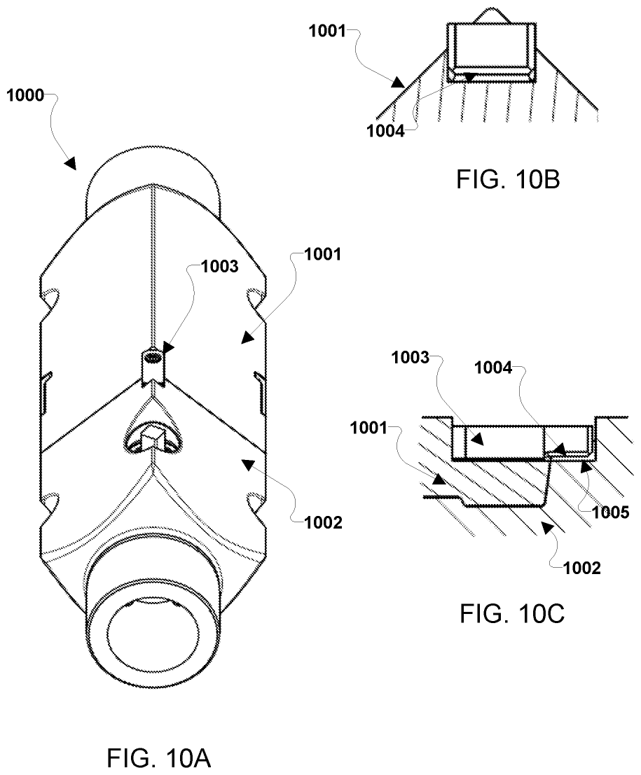

FIG. 10A is a block diagram of a robotic erectable joint 1000 with a square cross section including a repeatable alignment connector 1003, in accordance with one or more embodiments. The repeatable alignment connector 1003 may be a latch connection electrically connecting the first joint half 1001 to the second joint half 1002 when the two joint halves 1001 and 1002 are physically connected. In some various embodiments, the repeatable alignment connector 1003 may have a surface 1004 that extends from the first joint half 1001 (as illustrated in FIG. 10B) to interact with a surface 1005 of the second joint half 1002 to form the electrical connection therebetween as illustrated in FIG. 10C. The surfaces 1004 may include surface treatments to improve the electrical connection therebetween, such as gold treatments, etc. While illustrated as a latch connection, in other configurations, the repeatable alignment connector 1003 may be another type of connection, such as a nose connection, pin connection, hard point tip, etc.

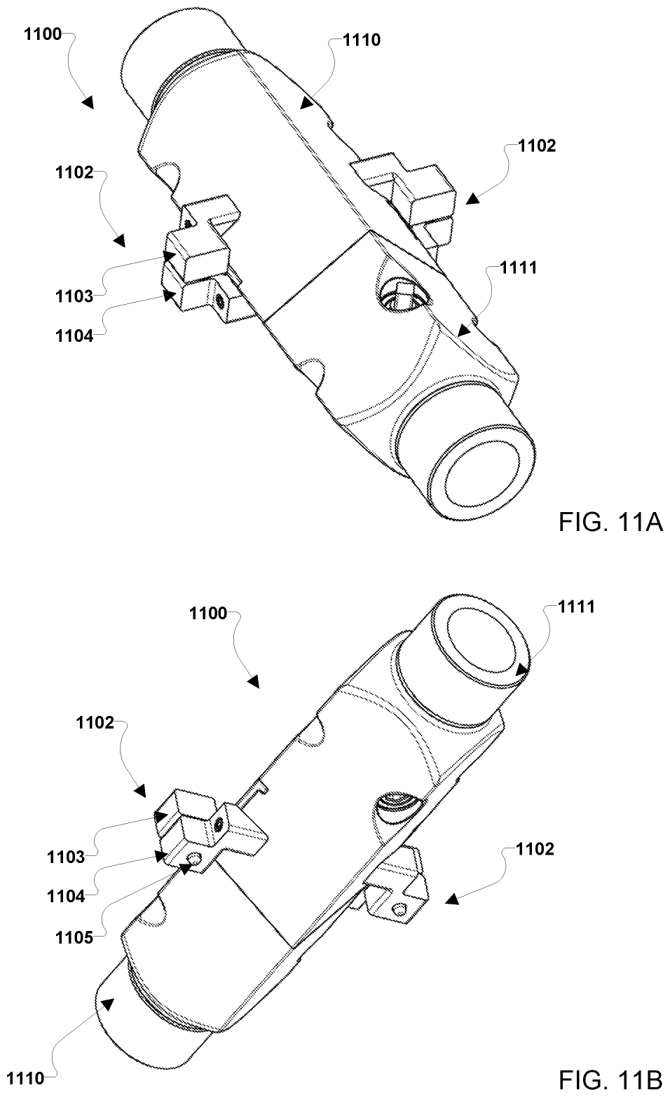

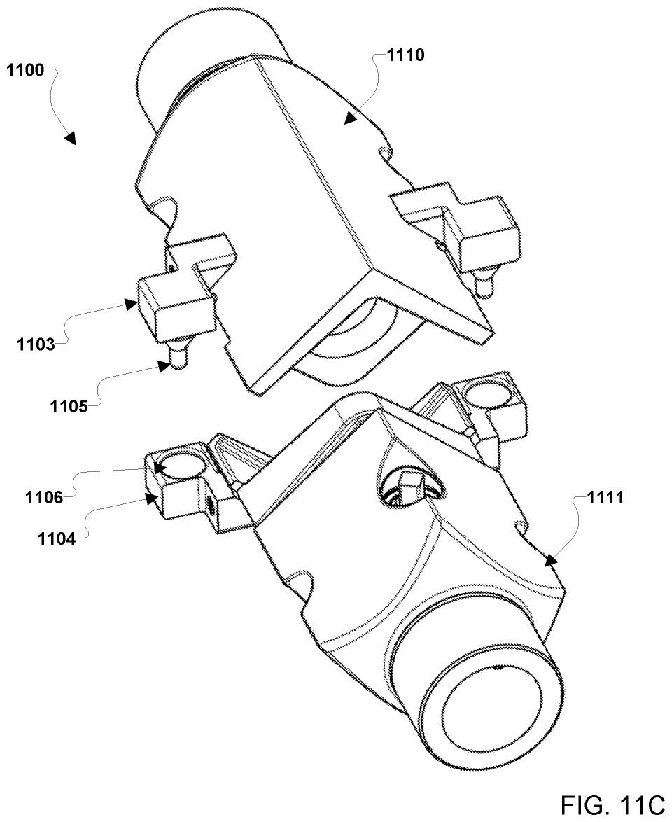

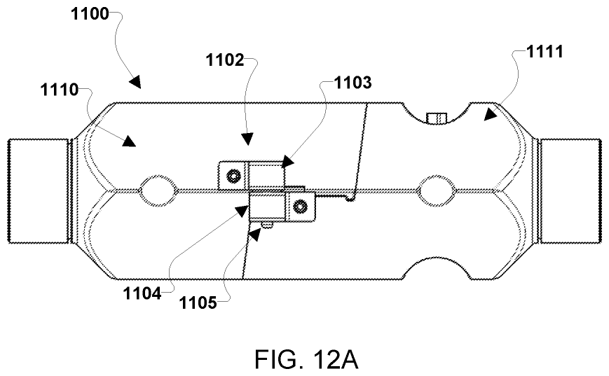

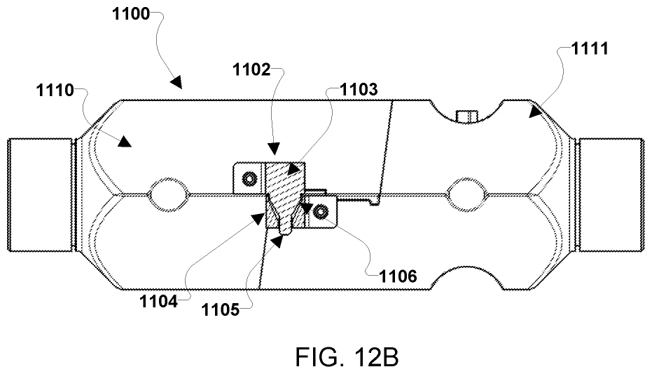

FIGS. 11A, 11B, 11C, 12A, and 12B are a block diagrams of a robotic erectable joint 1100 with a square cross section including coarse alignment structures 1102 in accordance with one or more embodiments. The joint 1100 is formed by connecting a first joint half 1110 and a second joint half 1111. The first joint half 1110 and the second joint half 1111 may each include respective portions of the coarse alignment structure 1102. For example, the first joint half 1110 may include first portion 1103 of the coarse alignment structure 1102 including a tongue 1105 or other extension type feature that mates with a second portion 1104 of the coarse alignment structure 1102 on the second joint half 1111 having a groove 1106 or other type receptacle feature configured to receive the tongue 1105. The coarse alignment structure 1102 may be affixed to the outside of the joint 1100. The coarse alignment structure 1102 may move the joint 1100 into the capture envelope.

FIG. 12A shows a block diagram of the robotic erectable joint of FIGS. 11A and 11B showing the joint halves 1110 and 1111 connected. FIG. 12B is a partial cut-away block diagram of the robotic erectable joint in FIG. 12A showing the internal interactions of the coarse alignment structures. As shown in FIG. 12B, when the joint halves 1110 and 1111 are fully inserted, there may be no contact between the first portion 1103 and second portion 1104.

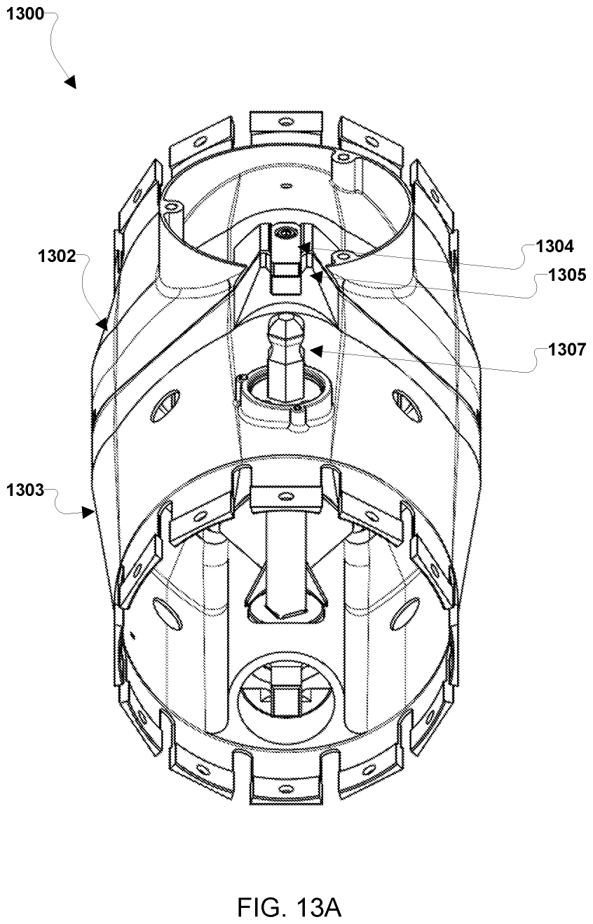

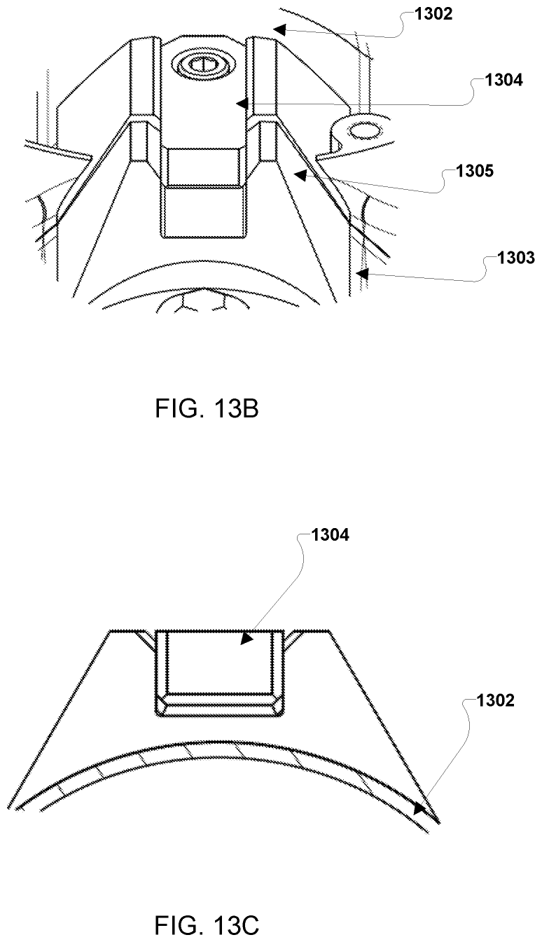

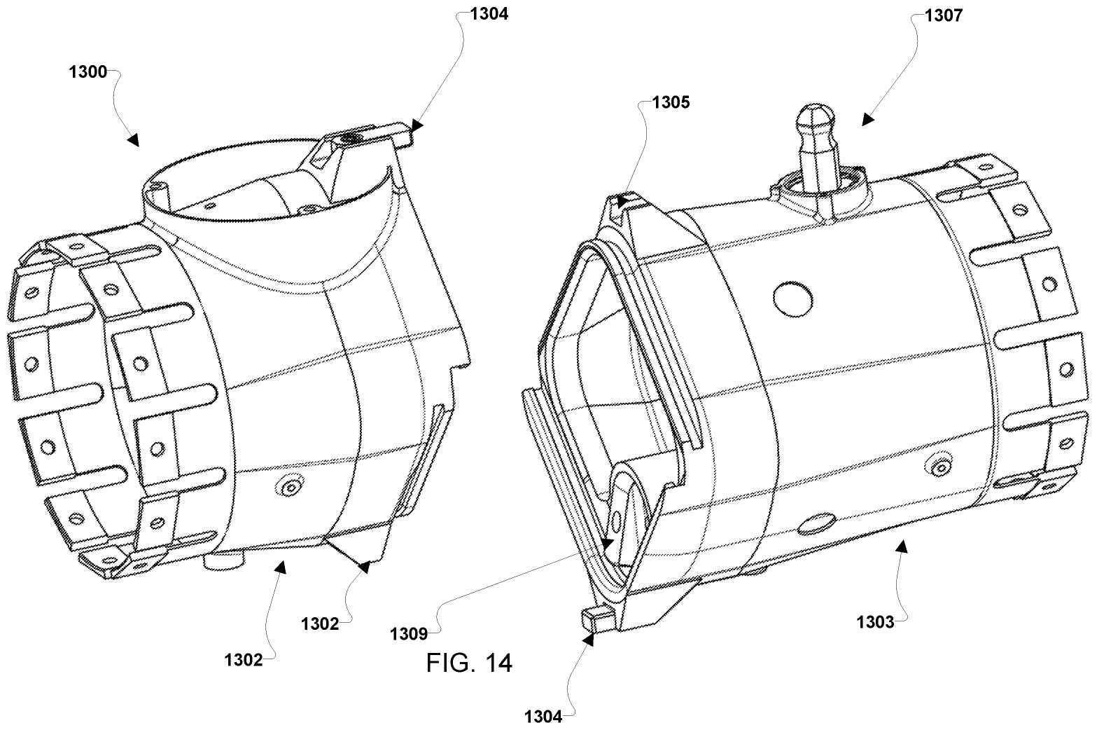

FIGS. 13A, 13B, 13C, 14, and 15 illustrate features of another robotic erectable joint 1300 with a square cross section showing a first joint half 1302 and a second joint half 1303 in connected and disconnected states in accordance with one or more embodiments. The joint 1300 may include a repeatable alignment connector 1304 that may be a latch connection electrically connecting the first joint half 1302 to the second joint half 1303 when the two joint halves 1302 and 1303 are physically connected. Additionally, the repeatable alignment connector 1304 may operate as a coarse alignment structure. As illustrated in FIG. 14, one repeatable alignment connector 1304 may be disposed on the first joint half 1302 and another repeatable alignment connector 1304 may be disposed on the second joint half 1303. The repeatable alignment connectors 1304 may insert into recesses 1305 on the joint halves 1302, 1303. In various embodiments, the repeatable alignment connector 1304 may extend from the first joint half 1302 (as illustrated in FIG. 13B) to interact with the recess of the second joint half 1303 to form the electrical connection therebetween as illustrated in FIG. 13C. The repeatable alignment connector 1304 may be similar to repeatable alignment connector 1003 discussed herein. The repeatable alignment connector 1304 may operate as a precision alignment feature that can be added to improve rotational alignment of the joint 1300.

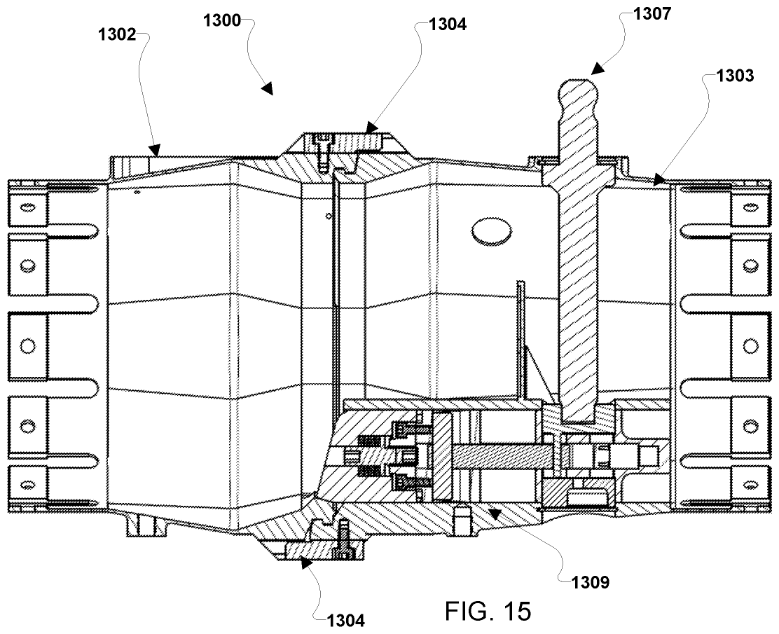

The two halves 1302, 1303 may be aligned, brought together, and one or more mechanisms, such as lock 1309 (FIG. 14) may be actuated by drive shaft 1307 and driven to lock the robotic erectable joint 1300. The joint 1300 may include a stop plate in the drive train of the lock 1309 that may be configured to cause the unlocked state to be unstable, so that the joint 1300 defaults to the capture state. In the capture state, the joint 1300 may be forced together and the joint 1300 may be secure (captured and held in place so it cannot come apart), but it does not necessarily have a preload and cannot resist significant forces and moments. The stop plate may be configured so that a constant torque is required to unlock the joint 1300, and should this torque be removed, the joint 1300 may rapidly revert back to the capture state. FIG. 15 illustrates the interactions between the drive shaft 1307 and the lock 1309 to lock the first joint half 1302 to the second joint half 1303. Additionally, an adjuster may be included to enable capture spring adjustment.

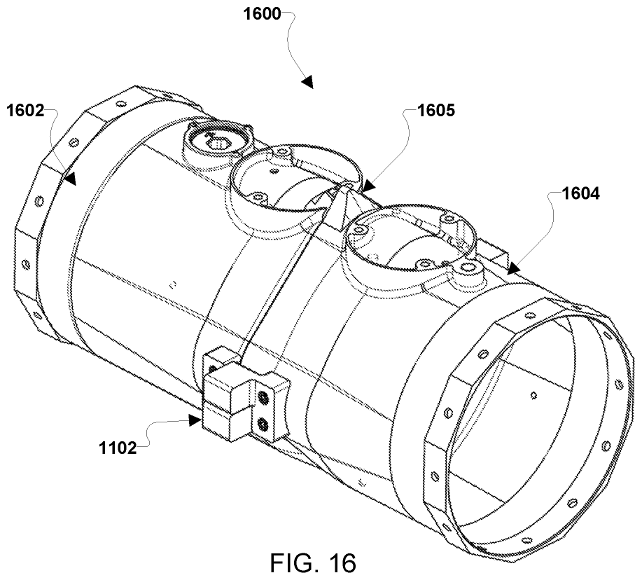

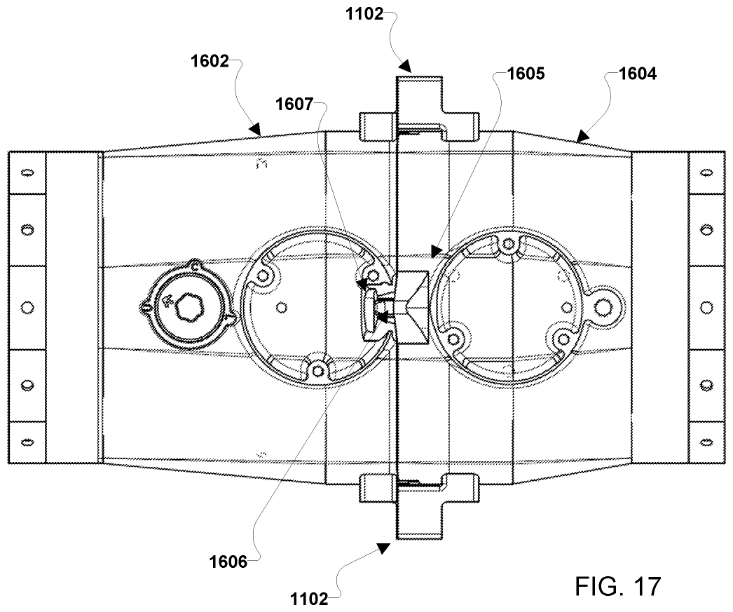

FIGS. 16 and 17 illustrate a robotic erectable joint 1600 with a square cross section showing a first joint half 1602 and a second joint half 1604 connected in accordance with one or more embodiments. The joint 1600 may include coarse alignment structures 1102 as discussed previously and a repeatable alignment connector 1605. The repeatable alignment connector 1605 may include a hard point 1606 configured to scratch a soft plate 1607 to establish an electrical connection between the first joint half 1602 and the second joint half 1604 when connected.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A joint, comprising:
first joint half; and
a second joint half configured to connect to the first joint half to thereby form the joint when so connected,
wherein the joint has a noncircular cross section.

2. The joint of claim 1, wherein:
the first joint half includes a mechanism configured to lock to the second joint half in a locked state and unlock from the second joint half in an unlocked state.

3. The joint of claim 2, wherein the first joint half comprises a stop plate in a drive train, wherein the stop plate is configured to cause one or more states of the first joint half to be unstable.

4. The joint of claim 3, wherein at least one of the one or more states of the first joint half that are unstable are an unlock state or a capture state.

5. The joint of claim 3, wherein the stop plate is configured such that a continuous torque is required to unlock the joint after the first joint half and the second joint half are connected.

6. The joint of claim 2, wherein:
the first joint half comprises a spring; and
the joint is configured such that a force of the spring may be adjusted after the first joint half and the second joint half are connected or assembled.

7. The joint of claim 6, wherein:
the first joint half comprises a preload spring; and
the joint is configured such that a force of the preload spring may be adjusted after the first joint half and the second joint half are connected.

8. The joint of claim 1, wherein the first joint comprises a bonding strap configured to provide a low resistance electrical path across the joint after the first joint half and the second joint half are connected.

9. The joint of claim 1, wherein the first joint half and the second joint half each include a respective connector configured to align with one another to form a connection between the first joint half and the second joint half.

10. The joint of claim 9, wherein the connection is an electrical connection, an optical connection, a data connection, or a thermal connection.

11. The joint of claim 1, wherein the first joint half and the second joint half each include a respective electrical connector configured to align with one another to form an electrical connection between the first joint half and the second joint half and the respective electrical connectors are located away from structural contact surfaces of the joint.

12. The joint of claim 1, wherein the first joint half or the second joint half include an indicator configured to visually signal rotational alignment of the joint.

13. The joint of claim 1, wherein the second joint half and the first joint half are configured to form a continuous contact surface when connected.

14. The joint of claim 1, wherein the second joint half and the first joint half are configured to be electrically conductive across one another when connected.

15. The joint of claim 1, wherein the first joint half and the second joint half each include a repeatable alignment connector configured to provide electrical conductivity between the first joint half and the second joint half when connected.

16. The joint of claim 15, wherein the repeatable alignment connector is a latch connection.

17. The joint of claim 1, wherein the first joint half and the second joint half each include a respective portion of a coarse alignment structure.

18. The joint of claim 17, wherein the coarse alignment structure is a tongue and groove structure.

19. The joint of claim 1, wherein the joint is configured to have a linear response in both tension and compression for axial, bending, shear, and torsional loading when the first joint half and the second joint half are connected in a locked state.

20. The joint of claim 1, wherein the joint is a robotically assembled joint, an Extra Vehicular Activity (EVA) assembled joint, or an Intra Vehicular Activity (IVA) assembled joint, and wherein the noncircular cross section is a square cross section.
